(19) United States
(12) Patent Application Publication
(10) Pub. No.: US 2005/0125784 A1
(43) Pub. Date: Jun. 9, 2005

(54) Hardware environment for low-overhead profiling

(75) Inventors: Qing Yang, Saunderstown, RI (US); Ming Zhang, Kingstown, RI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Rhode Island Board of Governors for Higher Education, Providence, RI (US)

(21) Appl. No.: 10/987,578

(22) Filed: Nov. 12, 2004

Related U.S. Application Data
(60) Provisional application No. 60/519,883, filed on Nov. 13, 2003.

(51) Int. Cl. G06F 9/45

(52) U.S. Cl. 717/158

(57) ABSTRACT

A hardware environment for low-overhead profiling (HELP) technology significantly reduces profiling overhead and supports runtime system profiling and optimization. HELP utilizes a specifically designed embedded board. An embedded processor on the HELP board offloads tasks of profiling/optimization activities from the host, which reduces system overhead caused by profiling tools and makes HELP especially suitable for continuous profiling on production systems. By processing the profiling data-in parallel and providing feedback promptly, HELP effectively supports on-line optimizations including intelligent prefetching, cache managements, buffer control, security functions and more.

### CROSS-REFERENCES TO RELATED APPLICATIONS

The present application claims priority from U.S. Provisional Patent Application No. 60/519,883, filed on Nov. 13, 2003, which is incorporated by reference.

### STATEMENT AS TO RIGHTS TO INVENTIONS MADE UNDER FEDERALLY SPONSORED RESEARCH OR DEVELOPMENT

This invention was supported in part by grant numbers MIP-9714370 and CCR-0073377 from the National Science Foundation (NSF). The U.S. Government has certain rights in the invention.

### BACKGROUND OF THE INVENTION

The present invention relates to monitoring or profiling computer systems.

Performance monitoring or profiling of computer systems is an important tool both for hardware and software engineering. Generally, the profiling has been performed to evaluate existing and new computer architectures by collecting data related to the performance of the computer system. A variety of information may be collected by a monitoring or profiling tool, for example: cache misses, number of instructions executed, number of cycles executed, amount of CPU time devoted to a user, and the number of instructions that are used to optimize a program, to name just a few.

Different designs of computer hardware structures, such as a computer memory or cache, may exhibit significantly different behavior when running the same set of programs. A monitoring or profiling tool may be useful in identifying design strengths or flaws. Conclusions drawn from the data collected by the profiling tool may then be used to affirm or modify a design as part of a design cycle for a computer structure. Identifying certain design modification, flaws in particular, before a design is finalized may improve the cost effectiveness the design cycle.

Instrumentation-based profiling and sampling-based profiling are two common conventional techniques for collecting runtime information about programs executed on a computer processor. Profiling information obtained with these techniques is typically utilized to optimize programs. Conclusions may be drawn about critical regions and constructs of the program by discovering, for example, what portion of the execution time, of the whole program, is spent executing which program construct.

The instrumentation-based profiling involves the insertion of instructions or code into an existing program. The extraneous instructions or code are inserted at critical points. Critical points of the existing program may be, for example, function entries and exits or the like. The inserted code handles the collection and storage of the desired runtime information associated with critical regions of the program. It should be noted that at runtime the inserted code becomes integral to the program. Once all the information is collected the stored results may be displayed either as text or in graphical form. Examples of instrumentation-based profiling tools are prof, for UNIX operating systems, pixie for Silicon Graphics (SGI) computers, CXpa for Hewlett-Packard (HP) computers, and ATOM for Digital Equipment Corporation (DEC) computers.

The sampling-based profiling involves sampling the program counter of a processor at regular time intervals. For example, a timer is set up to generate an interrupt signal at the proper time intervals. The time duration between samples is associated with a time duration spent executing the program construct of the code profiled that the program counter is pointing at. A program construct may be, for example, a function, a loop, a line of code or the like. Data relating to time durations with program constructs provide a statistical approximation of the time spent in different regions of the program. Examples of sampling based profiling tools are gprof by GNU, Visual C++Profiler and Perfmon, by Microsoft, and Vtune by Intel.

As noted above, the program or performance profiling has been used as a mechanism to observe system activities. Program profiling, however, has not been used extensively at runtime to optimize the system since profiling and optimization generates overhead, which diverts the resources of the system. Researches have been conducted to minimize the overhead to enable runtime profiling and optimization. Profiling and optimization overhead is mainly caused by the process of gathering raw data, recording of raw data, processing of raw data, and feedback.

Profiling tools perform sampling to gather raw data using instrumentation code or interrupts. The generated raw data are saved to local disks or system buffer. Vtune, for example, transfers profiling data to a remote system via network. Saving data to a local storage device causes contention with I/O activities of the system while transferring via network causes skew for network activity profiling. Profiling tools usually delay processing data until enough profiling data have been gathered. Online optimizers, such as Morph, use system idle time to analyze data. Optimized feedback solutions are applied to host systems.

Among other improvements in the computing technology, it would be desirable to find a way to minimize the profiling overhead.

### BRIEF SUMMARY OF THE INVENTION

The present embodiments are directed to minimizing the overhead associated with profiling and optimization. If the profiling overhead is minimized or reduced substantially, it would enable a computer system to support continuous profiling and optimization at runtime. The present embodiment discloses a hardware environment for low-overhead profiling (HELP), which is a specifically designed embedded processor board (as referred to as “HELP board” or “profiling board”) to offload most of profiling and/or optimization functions from the host CPU to the HELP board. As a result, much of profiling and optimization operations are performed in parallel to applications to be optimized, making it possible to carry out runtime profiling and optimization on production systems with minimum overhead.

In one embodiment, HELP technology is implemented as a general framework with a set of easy-to-use APIs to enable existing or new profiling and optimization techniques to make use of HELP for low overhead profiling and optimization on production systems. Functions running on the HELP board are in the forms of plug-ins to be loaded by a user at runtime. These do not generate overhead on host system and thus do not degrade host system performance.

In one implementation, the HELP board has standard interface such as PCI, PCI-X, or Inniband connected to the system bus of a computer system and a set of easy-to-use APIs to allow system architects to develop their own efficient profiling and optimization tools for optimization or security purposes. The HELP board can be directly plugged into a server or storage system to speed up storage operations and carry out security check functions, as is done by a graphics accelerator card. U.S. patent application Ser. No. 10/970,671, entitled “A Bottom-Up Cache Structure for Storage Servers,” filed on Oct. 20, 2004, discloses exemplary storage servers and is incorporated by reference. A HELP approach also reduces or eliminates data skews associated with conventional profiling methods since the profiling is done at the HELP board rather than by the host.

In one embodiment, a computer system includes a main processor to process data; a main memory coupled to the main processor and store data to be processed by the main processor; a system interconnect coupling the main processor to one or more components of the computer systems; and a profiling board coupled to the system interconnect and configured to perform profiling operations in parallel to operations performed by the main processors. The profiling board includes a board interface coupled to the system interconnect to receive raw data for profiling; and a local processor to process the raw data.

In another embodiment, a method for performing program profiling in a computer system is disclosed. The method comprises gathering raw data on an application program being executed by a host module of the computer system, the host module including a main processor and a main memory; transferring the gathered raw data to a profiling board coupled to the host module via a system interconnect; and processing the raw data received from the host module at the profiling board to obtain performance information associated with the application program while the host module is performing an operation and is in runtime, wherein the profiling board including an embedded processor to run a profiling program. The profiling board processes the raw data while the host is executing the same instance of the application program that was used to gather the raw data according to one implementation.

The method further comprises generating optimization information at the profiling board based on the processing step, the optimization information including information about a means to improve the execution of the application program by the host module; and transferring the optimization information to the host module, so that the optimization information can be implemented by the host module.

The method may additionally comprise allocating a resource of the profiling board for use by a profiling tool associated with the host module; and releasing the allocated resources once the profiling of the application program has been completed.

In yet another embodiment, a computer readable medium including a computer program for profiling an application program being run by a host of a computer system is disclosed. The computer program includes code for gathering raw data on the application program being run by the host, the host including a main processor and a main memory; code for transferring the gathered raw data to a profiling board coupled to the host via a system interconnect; and code for processing the raw data received from the host at the profiling board to obtain performance information while the host is performing an operation and is in runtime, wherein the profiling board including an embedded processor to run a profiling program.

The computer program further comprises code for generating optimization information based on the raw data processed by the profiling board; and code for transferring the optimization information to the host, so that the host can implement the optimization information and improve the performance of the computer system on the fly.

### BRIEF DESCRIPTION OF THE DRAWINGS

FIG. 1 is a simplified block diagram of an exemplary computer system which may incorporate embodiments of the present invention.

FIG. 2 illustrates a HELP board according to one embodiment of the present invention.

FIG. 3 illustrates a plurality of APIs managed by the host according to one embodiment of the present invention.

FIG. 4 illustrates a plurality of exemplary plug-ins that are used to support processing of raw data received by a HELP board from the host according to one embodiment of the present invention.

FIG. 5 illustrates an exemplary profiling and optimization process according to one embodiment of the present invention.

### DETAILED DESCRIPTION OF THE INVENTION

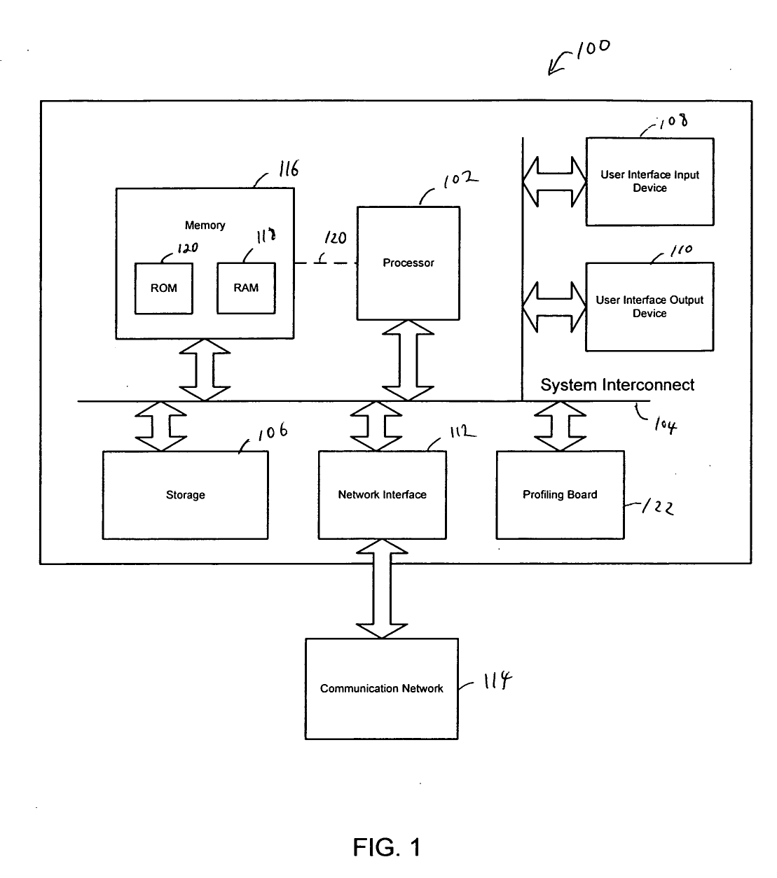

FIG. 1 is a simplified block diagram of an exemplary computer system 100 which may implement embodiments of the present invention. Computer system 100 typically includes at least one processor or central processing unit (CPU) 102, which communicates with a number of peripheral devices via a system interconnect 104. System interconnect 104 is a may be a bus subsystem or switch fabric, or the like. The system interconnect, herein, is also referred to as the main internal bus. These peripheral devices may include a storage 106. Storage 106 may be enclosed within the same housing or provided externally and coupled to the system interconnect via a communication link, e.g., SCSI. Storage 106 may be a single storage device (e.g., a disk-based or tape-based device) or may comprise a plurality of storage devices (e.g., a disk array unit).

The peripheral devices also include user interface input devices 108, user interface output devices 110, and a network interface 112. The input and output devices allow user interaction with computer system 100. The users may be humans, computers, other machines, applications executed by the computer systems, processes executing on the computer systems, and the like. Network interface 112 provides an interface to outside networks and is coupled to communication network 114, to which other computers or devices are coupled.

User interface input devices 108 may include a keyboard, pointing devices (e.g., a mouse, trackball, or touchpad), a graphics tablet, a scanner, a touchscreen incorporated into the display, audio input devices (e.g., voice recognition systems), microphones, and other types of input devices. In general, use of the term “input device” is intended to include all possible types of devices and ways to input information into computer system 100 or onto network 114.

User interface output devices 110 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 100 to a user or to another machine or computer system.

Processor 102 is also coupled to a memory subsystem 116 via system interconnect 104. Memory subsystem 116 typically includes a number of memories including a main random access memory (RAM) 118 for storage of instructions and data during program execution and a read only memory (ROM) 120 in which fixed instructions are stored. In one implementation, a dedicated bus 120 couples the processor and the memory subsystem for faster communication between these components.

Memory subsystem 116 cooperate with storage 106 to store the basic programming and data constructs that provide the functionality of the various systems embodying the present invention. For example, databases and modules implementing the functionality of the present invention may be stored in storage subsystem 106. These software modules are generally executed by processor 102. In a distributed environment, the software modules and the data may be stored on a plurality of computer systems coupled to a communication network 114 and executed by processors of the plurality of computer systems.

Generally, storage 106 provides a large, persistent (non-volatile) storage area for program and data files, and may include a hard disk drive, a floppy disk drive along with associated removable media, a Compact Digital Read Only Memory (CD-ROM) drive, an optical drive, or removable media cartridges. One or more of the drives may be located at remote locations on other connected computers coupled to communication network 114.

System interconnect 104 provides a mechanism for letting the various components and subsystems of computer system 100 communicate with each other as intended. The various subsystems and components of computer system 100 need not be at the same physical location but may be distributed at various locations within distributed network 100. Although system interconnect 104 is shown schematically as a single bus, alternate embodiments of the bus subsystem may utilize multiple buses. The system interconnect may also be a switch fabric.

Computer system 100 itself can be of varying types including a personal computer, a portable computer, a storage server, a workstation, a computer terminal, a network computer, a television, a mainframe, or any other data processing system. Due to the ever-changing nature of computers and networks, the description of computer system 100 depicted in FIG. 1 is intended only as a specific example for purposes of illustrating the preferred embodiment of the present invention. Many other configurations of computer system 100 are possible having more or less components than the computer system depicted in FIG. 1.

As used herein, the term “host” or “host system” refers to a group of components including processor 102 and a memory (e.g., memory subsystem 116). The host may also include other components, e.g., system interconnect 104. A profiling board 122 is coupled the host to reduce profiling overhead according to HELP technology. Board 122 enables much of the profiling and optimization functions to be offloaded from the host to the HELP board. That is, much of the profiling and optimization operations are performed in parallel to applications being run by the host, making it possible to carry out runtime profiling and optimization on production systems with significantly reduced overhead.

HELP technology is a hybrid of hardware and software and includes HELP board 122, software running on a host system, and software running on HELP board 122. HELP Board contains an embedded processor that provides computing power to whole system and offloads the processing task of raw data from a host processor. In this way, profiling is performed during runtime in parallel to host operations, from which on-line optimization can benefit. Software (“first software”) running on a host system provides APIs to enable other profiling tools to utilize the functionality of HELP. The first software runs on host systems as a library or a kernel module that exports routines for profiling tools running in kernel space. Software (“second software”) running on HELP Board includes an embedded operating system to drive HELP Board, a library to provide helper routines to ease the post-processing on raw data, and plug-ins to help profiling tools to implement user-defined functionalities.

FIG. 2 illustrates HELP board 122 according to one embodiment of the present invention. In the present embodiment, board 122 is an embedded system board that plugs into host system's slot (e.g., PCI slot), which couples to the system interconnect. Board 122 includes a processor 202, a RAM 204, a ROM 206, a network interface 208, a primary bus 210, a secondary PCI slot 212, a control logic 214, and a serial port 216. In the present implementation, the primary bus 210 is a PCI bus that is coupled to system interconnect 104 of the host. A switch fabric or the like may be used in place of the bus system 210.

Embedded processor 202 is used to process raw profiling data. The processor also supports Message Unit (not shown) that provides a mechanism for transferring data between a host system and the embedded processor on HELP board 122. The Message Unit notifies the respective system of the arrival of new data through an interrupt. Both host systems and HELP board can process the interrupts via registered handlers. Like many other embedded systems, the present Message Unit supports common functionalities, e.g., Message Registers, Doorbell Registers, Circular Queues and Index Registers.

RAM 204 includes at least two parts. One part of the memory is used to store code and data used by the embedded processor while another part of the RAM is shared between the local embedded processor and the host processor. Flash ROM 206 on board includes the embedded operating system code and data processing routines. Network interface (or Ethernet port) 208 and serial port 216 provide connections to external systems. Secondary PCI slot 212 is used to provide flexible expandability to the board. For example, a disk connected to HELP board through the secondary PCI can be used to save profiling data for post-processing. Control logic 214 is used to implement the system timer and other control functions.

In the present implementation, when HELP board 122 is plugged into a host PCI slot, it acts as a PCI device and exports several registers and a region of I/O memory. Although it can be accessed via low-level PCI-specific APIs directly, a set of upper-level APIs is provided to encapsulate the low-level details of PCI devices to make HELP more user friendly Profiling tools can use these upper-level APIs to finish tasks without knowing the low-level hardware details.

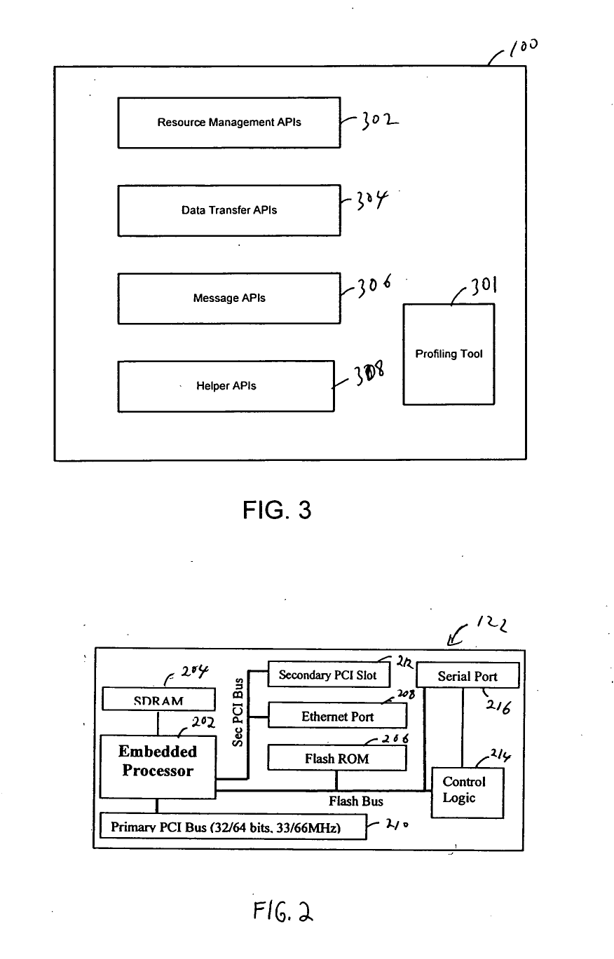

FIG. 3 illustrates a plurality of APIs managed by the host according to one embodiment of the present invention. The APIs may be stored in ROM 120 or storage 106, or a combination thereof. The APIs may also be stored in other non-volatile storage areas. A profile tool or optimizer 301 gathers raw data and transfers these data to the HELP board using the APIs below.

Resource Management APIs 302 are used to manage the resources of the board. Before using HELP board, profiling tools need to initialize the board and request resources from it. These resources include I/O memory, registers, Message Units, Direct Memory Access channels, and the like. After finishing using the board, profiling tools release these resources. Request and release routines are provided for each type of resources.

Data Transfer APIs 304 are used to manage data transfers to and from the host and board. In the present implementation, different read/write routines are provided to transfer data in different size units such as Byte, Word, and DWORD. For larger size data transfer operations, “memcpy” is provided.

Message APIs 306 are encapsulation of the Message Unit. These APIs are used to provide a mechanism to exchange information between a host processor and an embedded processor. Since each Message Unit is also a hardware resource, to request and free the use of Message Unit is accomplished via corresponding resource management APIs. Profiling tools can use message APIs to send user-defined messages to the embedded processor. They may also register callback routines via message APIs, which are invoked when corresponding process running on the embedded processor send messages back to them. Additional helper APIs 308 are provided for other operations, e.g., error handling routines and status reporting routines.

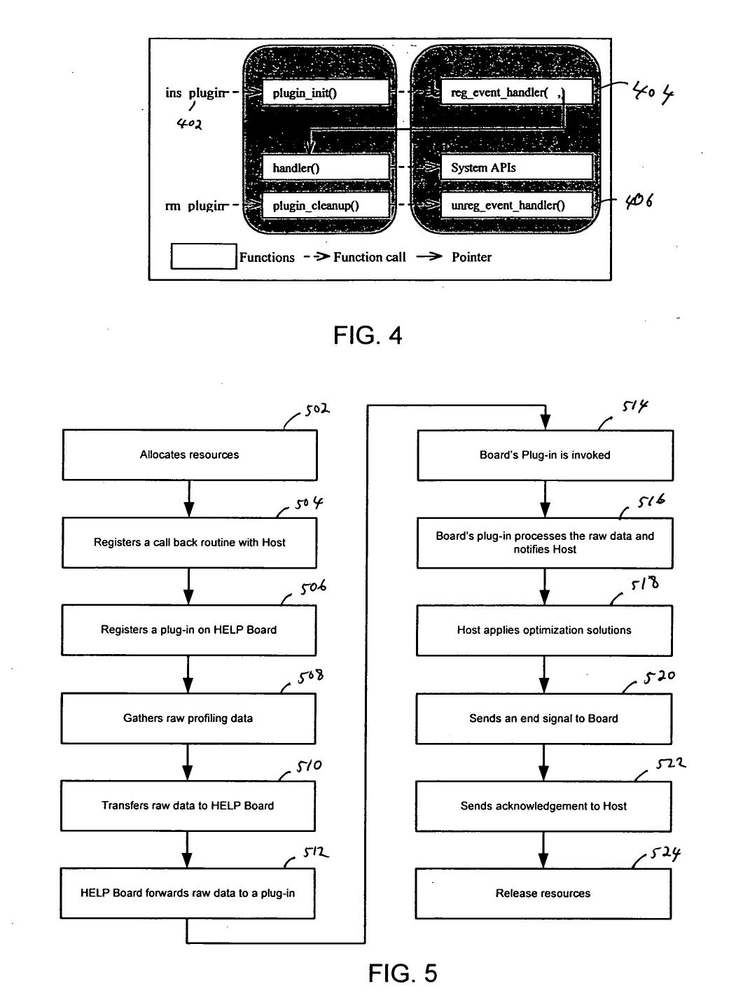

FIG. 4 illustrates a plurality of exemplary plug-ins that are used to support processing of raw data received by HELP board 122 from the host according to one embodiment of the present invention. Each profiling tool either uses HELP-predefined plug-ins to finish common profiling or provides a plug-in to HELP in order to finish its specific functionality. For example, a profiling tool may save the raw profiling data to a disk for later use. Alternatively, an on-line optimizer may analyze raw profiling data, deduct instructions that guide how to provide optimization and feedback to the host system on the fly. The optimizer may even use the instructions to guide cross-compile compiler running on HELP board 122 to compile optimized code for host system and apply that optimized code to host directly. These specific functionalities are determined by profiling tools and implemented as specific plug-ins.

HELP provides a unified interface to plug-ins using several APIs. Each plug-in uses API ins_plugin 402 to link with the system on HELP board 122 and register at least one event handler using API reg_event_handler 404. This handler is called when the board system receives a message from the host. A plug-in can transfer certain data to a host and notify it by using the API send_data (not shown) with the information on data address and data length. Then the corresponding registered call back routine on the host fetches the data and carries out its specific task. After finishing all tasks, the plug-in uses unreg_event_handler 406 to unregister previously registered handlers and unloads itself by rm_plugin 408.

With its unified interface and low overhead data collection, HELP board 122 can be utilized in many system level profiling and optimization environments. Profiling tools gather raw profiling data from a host and transfer the data to HELP board 122. Then the plug-ins process and analyze the data in parallel to host operations. They can also store raw data or processed data to an optional disk or send them to remote systems via a network if the network is not part of the system being profiled. This on-line processing is useful for a real-time feedback and is used to dynamically measure a system.

Morph is an exemplary optimizer that may be used in HELP environment. Morph provide on-line optimization to programs, using idle time of the host to process profiling data and to recompile optimized code offline. By offloading much or all processing to the HELP board, an optimizer, such as Morph, may be enhanced to allow the host to keep running while processing profiling data and recompiling optimized code on the fly. Accordingly, heavy-loaded system can benefit from this approach even without the availability of substantial periods of idle time.

Similarly, by monitoring dynamic file system access patterns and transferring profiling data to HELP board 122, an optimizer can use highly accurate algorithms, which tend to be complex, to predict future access patterns and direct the host file system to use better cache replacement and prefetching policies. By offloading the computing of detecting and deduction algorithms, such an optimizer can significantly reduce the host's performance loss caused by these algorithms and can use complex algorithms to obtain larger improvement while the extra overhead caused by algorithms is moved to HELP board 122.

FIG. 5 illustrates an exemplary profiling and optimization process according to one embodiment of the present invention. The description below relates to the use of a continuous on-line optimizer (e.g., profile tool 301 of FIG. 3). At first, the HELP functionalities are initializes on both the host and HELP Board. The optimizer locates HELP Board and allocates I/O memory resource using resource management APIs (step 502). The optimizer also registers a call back routine with the host in order to get feedback from HELP (step 504). To process raw profiling data on-line, a plug-in for the optimizer is registered on the HELP Board (step 506).

During runtime, the optimizer runs on the host and keeps gathering raw profiling data (step 508). The gathered raw data are transferred to the HELP board (step 510). The optimizer may transfer these data to the board continuously or in a larger unit using data transfer API. After each data transfer, the optimizer uses the message API to notify HELP board 122 that the data is ready, using a specific interrupt. The HELP Board receives this message and forwards it to the corresponding plug-in (step 512). Then the plug-in is invoked with this message and the data pointer, and processes the raw data according to the user-defined criteria (step 514). After the plug-in gathers enough raw data and processes these data to obtain optimization solutions, it notifies the host system (step 516). The call back routine in the host receives this notification and applies optimization solutions to system (step 518). This finishes one optimization loop. Steps 508 to 518 are repeated until the completion of profiling and optimization.

Once profiling and optimization are completed, the optimizer uses a message API to send an end signal to the HELP board (step 520). The plug-in on the board will finish its processing and send an acknowledge message to the host (step 522). Then the optimizer releases resources and terminates the process (step 524). The plug-in also unloads from HELP.

The present invention has been described in terms of specific embodiments. The embodiments above been provided to illustrate the invention and enable those skilled in the art to work the invention. Accordingly, the embodiments above should not be used to limit or narrow the scope of the invention. The scope of the present invention should be interpreted using the appended claims.

1. A computer system, comprising:
a main processor to process data;
a main memory coupled to the main processor and store data to be processed by the main processor;
a system interconnect coupling the main processor to one or more components of the computer systems; and
a profiling board coupled to the system interconnect and configured to perform profiling operations in parallel to operations performed by the main processors, wherein the profiling board includes:
a board interface coupled to the system interconnect to receive raw data for profiling; and
a local processor to process the raw data.

2. The computer system of claim 1, wherein the profiling board includes a local bus coupling the board interface and the local processor.

3. The computer system of claim 1, wherein the board includes a local memory that is divided into a first portion and a second portion, the first portion being allocated for the local processor, the second portion being allocated for both the main processor and local processor.

4. The computer system of claim 1, the system interconnect is a bus system.

5. The computer system of claim 1, wherein the system interconnect includes a switch fabric.

6. The computer system of claim 1, further comprising: at least one resource management Application Program Interface (API), at least one data transfer API, and at least one message API.

7. The computer system of claim 6, the resource management API is used to allocate a resource of the profiling board to a profiling tool running on a host, the host including the main processor and the main memory, wherein the data transfer API is used to transfer data collected by the main processor to the profiling board.

8. A method for performing program profiling in a computer system, the method comprising:
gathering raw data on an application program being executed by a host module of the computer system, the host module including a main processor and a main memory;
transferring the gathered raw data to a profiling board coupled to the host module via a system interconnect; and
processing the raw data received from the host module at the profiling board to obtain performance information associated with the application program while the host module is performing an operation and is in runtime,
wherein the profiling board including an embedded processor to run a profiling program.

9. The method of claim 8, further comprising:
generating optimization information at the profiling board based on the processing step, the optimization information including information about a means to improve the execution of the application program by the host module; and
transferring the optimization information to the host module, so that the optimization information can be implemented by the host module.

10. The method of claim 8, wherein the profiling board including a local memory that is partitioned into at least a first portion and a second portion, the first portion being reserved for use only by the profiling board, the second portion being reserved for use by both the host module and the profiling board.

11. The method of claim 8, further comprising:
allocating a resource of the profiling board for use by a profiling tool associated with the host module; and
releasing the allocated resources once the profiling of the application program has been completed.

12. The method of claim 8, wherein the computer system includes at least one resource management Application Program Interface (API), at least one data transfer API, and at least one message API.

13. The method of claim 8, wherein the profiling board processes the raw data while the host is executing the same instance of the application program that was used to gather the raw data.

14. A computer readable medium including a computer program for profiling an application program being run by a host of a computer system, the computer program including:
code for gathering raw data on the application program being run by the host, the host including a main processor and a main memory;
code for transferring the gathered raw data to a profiling board coupled to the host via a system interconnect; and
code for processing the raw data received from the host at the profiling board to obtain performance information while the host is performing an operation and is in runtime,
wherein the profiling board including an embedded processor to run a profiling program.

15. The computer readable medium of claim 14, wherein the codes are stored in a plurality of computer readable media.

16. The computer readable medium of claim 14, wherein the computer program further comprises:
code for generating optimization information based on the raw data processed by the profiling board; and
code for transferring the optimization information to the host, so that the host can implement the optimization information and improve the performance of the computer system on the fly.
